(19) United States
(12) Patent Application Publication
(10) Pub. No.: US 2005/0044138 A1
(43) Pub. Date: Feb. 24, 2005

(54) System and method for managing access for an end user in a network environment

(75) Inventors: Mark Albert, Morrisville, NC (US); Robert M. Batz, Raleigh, NC (US); Richard L. Gray, Cary, NC (US); Louis F. Menditto, Raleigh, NC (US); Michael S. Sutton, Garner, NC (US); Tzu-Ming Tsang, Chapel Hill, NC (US); Pranav K. Tiwari, Bangalore (IN)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 10/645,139

(22) Filed: Aug. 21, 2003

(51) Int. Cl. G06F 15/16; G06F 17/60

(52) U.S. Cl. 709/203; 705/40

(57) ABSTRACT

An apparatus for managing network access is provided that includes a billing system element operable to receive one or more packets of a communication flow and to communicate with a price server. The price server is operable to receive a query from the billing system element associated with a pricing parameter relating to a data segment to be accessed by an end user associated with the communication flow. The price server is also operable to return a response to the billing system element that includes the pricing parameter relating to the data segment such that the end user can verify the pricing parameter before accessing the data segment.

### TECHNICAL FIELD OF THE INVENTION

This invention relates in general to the field of communications and, more particularly, to a system and method for managing access for an end user in a network environment.

### BACKGROUND OF THE INVENTION

Data networking architectures have grown increasingly complex in communication systems and environments. Communication tunnels or connections may be used in order to establish or to gain access to a network, whereby an end user or an object may initiate a tunneling protocol by invoking a selected location or a network node. The network node or central location may then provide a platform that the end user may use to conduct a communication session.

As the subscriber base of end users increases and/or becomes mobile, proper routing and efficient management of communication sessions and data flows becomes even more critical. Some network equipment may provide incorrect information or inaccurate data for the end user. In certain scenarios, an end user may not understand his financial obligation, which is about to be accepted. In other cases, an end user may seek to confirm one or more financial parameters associated with a data exchange. Thus, the ability to properly and quickly manage accurate information in a network environment presents a significant challenge to system designers and network operators.

### SUMMARY OF THE INVENTION

From the foregoing, it may be appreciated by those skilled in the art that a need has arisen for an improved management approach associated with providing access to an end user. In accordance with one embodiment of the present invention, a system and method for managing access for an end user are provided that greatly reduce disadvantages and problems associated with conventional network access management techniques.

According to one embodiment of the present invention, there is provided an apparatus for managing network access that includes a billing system element operable to receive one or more packets of a communication flow and to communicate with a price server. The price server is operable to receive a query from the billing system element associated with a pricing parameter relating to a data segment to be accessed by an end user associated with the communication flow. The price server is also operable to return a response to the billing system element that facilitates end user verification of the pricing parameter before permitting access to the data segment.

Certain embodiments of the present invention may provide a number of technical advantages. For example, according to one embodiment of the present invention a communications approach is provided that accurately manages user access. The client service gateway may parse IP packets transmitted between a user (client) and a server. For selected flows and for selected clients, a billing system may debit a user account based on the type and the quantity of information transmitted. In a general sense, the client service gateway may cooperate with a billing system element in order to charge an end user based on a particular event, a block of content, or a communication flow. Thus, the client service gateway may query one or more of the elements included within the billing system element in order to effectively distribute specific information to the end user. These operations may offer more granular pricing capabilities for both the end user and the billing entity. Such capabilities may also provide enhanced pricing options and billing capabilities for a network operator.

Yet another technical advantage associated with one embodiment of the present invention relates to pricing accuracy and confirmation features being provided to an end user. An end user may be properly notified how much his account will be charged for the selected content. This would further ensure that a given end user understands and, further, accepts the obligations being displayed or offered. Moreover, the elements within the billing system element may cooperate in order to confirm prices for selected access or designated information before the end user receives the requested data. Thus, the communication architecture provided may be used to execute per-click authorization in enabling one or more of the following functions: 1) granular content pricing, i.e. more granular than at a prepaid service level; 2) verification of the charge before serving the content; 3) L3/L4/L7 filtering; and 4) quota management offload in allowing a quota server to micromanage user quota for each request. Such functions may provide for a more sophisticated billing process that is capable of performing a wide array of complex tasks, which may be based on particular system needs. Certain embodiments of the present invention may enjoy some, all, or none of these advantages. Other technical advantages may be readily apparent to one skilled in the art from the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a simplified block diagram of a communication system for managing access to network resources in accordance with one embodiment of the present invention;

FIG. 2 is a simplified block diagram of a known user table (KUT) included within the communication system;

FIG. 3A is a simplified flowchart illustrating an example operation associated with a price server that may be included within the communication system;

FIG. 3B is a simplified flowchart illustrating an example operation associated with an advice of charge server that may be included within the communication system;

FIG. 3C is a simplified flowchart illustrating an example operation associated with a filtering process to be performed in the communication system; and

FIG. 3D is a simplified flowchart illustrating an example quota management operation to be performed in the communication system.

### DETAILED DESCRIPTION OF THE INVENTION

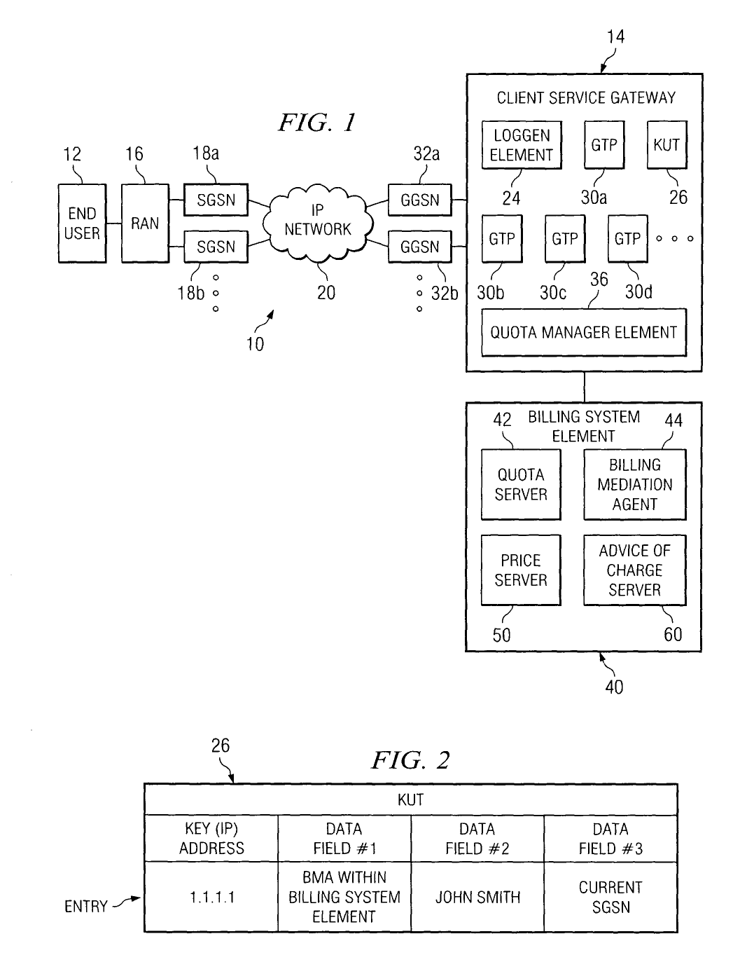

FIG. 1 is a simplified block diagram of a communication system 10 for managing network access. Communication system 10 includes an end user 12, a Content Services Gateway (CSG) 14, a radio access network (RAN) 16, multiple serving general packet radio service (GPRS) support nodes (SGSN) 18a and 18b, and an internet protocol (IP) network 20. Additionally, communication system 10 includes multiple gateway GPRS support nodes (GGSNs) 32a-b. In addition, CSG 14 may include a loggen element 24, a known user table (KUT) 26, multiple GPRS tunneling protocol (GTP) communications protocol elements 30a-d that facilitate communications between CSG 14 and any billing entity within communication system 10, and a quota manager element 36. Communication system 10 may additionally include a billing system element 40 that may include a quota server 42 and a billing mediation agent (BMA) 44. Billing system element 40 may also include a price server 50 and an advice of charge server 60.

Communication system 10 may be generally configured or arranged to represent a 2.5G communication architecture applicable to a Global System for Mobile (GSM) environment in accordance with a particular embodiment of the present invention. Communication system 10 may also be configured to reflect a version of any suitable GPRS tunneling protocol. Communication system 10 may additionally cooperate with first generation, 2G, and 3G architectures that provide some configuration for allocating data to an end user in a network environment. Communication system 10 may also be employed in any other suitable communication architecture that seeks to allocate or otherwise manage data or information in a network environment.

In accordance with the teachings of the present invention, communication system 10 operates to accurately manage user access. CSG 14 may parse IP packets transmitted between a user (client) and a server (or any other suitable destination). For selected flows and for selected clients, billing system element 40 debits a user account based on the type and quantity of information being transmitted. In a general sense, CSG 14 may cooperate with billing system element 40 in order to charge end user 12 based on a particular event, content, or communication flow. CSG 14 may query one or more of the elements included within billing system element 40 in order to effectively and accurately distribute information to end user 12.

Additionally, quota manager element 36 may operate in conjunction with price server 50 and advice of charge server 60 to provide granular content pricing. End user 12 may be notified how much his account will be charged for the selected content. Associated operations may include a proverbial ‘price check’ being provided to end user 12 before end user 12 commits to a financial obligation. Other operations may include price confirmations that are displayed to end user 12. These features could potentially ensure that end user 12 understand and accepts the obligations being tendered. Moreover, the elements within billing system element 40 may execute these operations for selected access or information before end user 12 receives the requested data.

The design of communication system 10 allows flows to be designated for further, detailed inspection by quota server 42, or by end-user 12, and some flows to be designated to be handled at high-speed within CSG 14. The design also provides a mechanism for quota server 42 to specify pricing of the content, or the end-user to choose to accept the charges for the content about to be received. The architecture of communication system 10 essentially separates these roles so that the user dialog can be defined on a ‘true’ server with the customary set of full web-developer toolkits. Communication system 10 also allows redirection to different servers for different reporting conditions based on particular networking or operator needs.

Thus, communication system 10 may be used to execute per-click authorization in enabling one or more of the following functions: 1) price server 50 is leveraged to enable quota server 42 to provide granular content pricing, i.e. more granular than at the CSG service level; 2) advice of charge server 60 may be used to perform a network address translation (NAT) or an HTTP redirect of the user session to a server to query end user 12 to verify the charge before serving the content; 3) L3/L4/L7 filtering may be performed; and 4) quota management offload may be executed in allowing quota server 42 to micromanage user quota for each request.

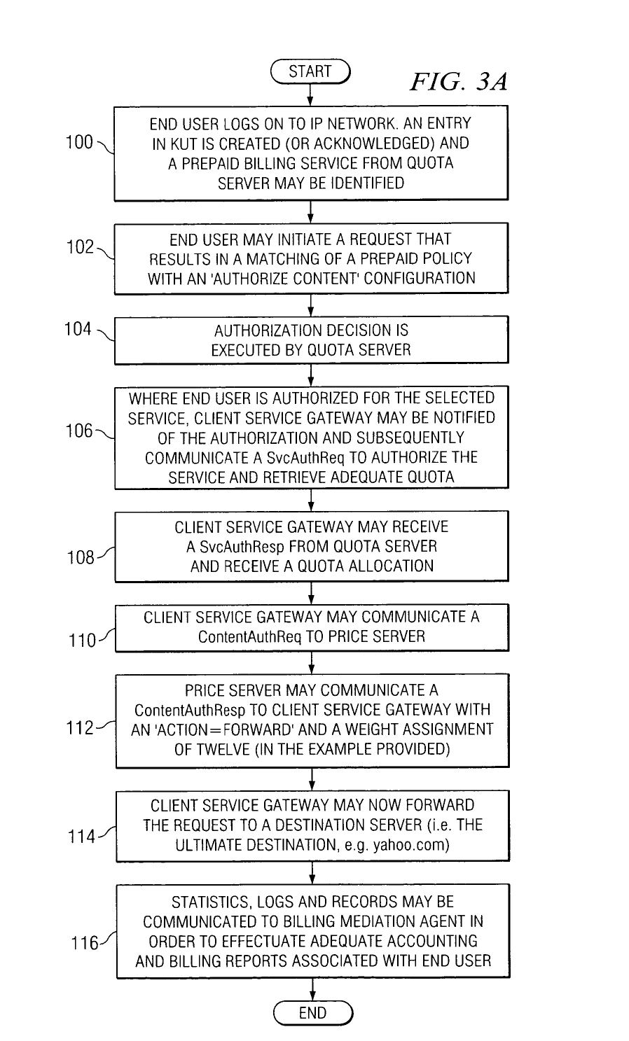

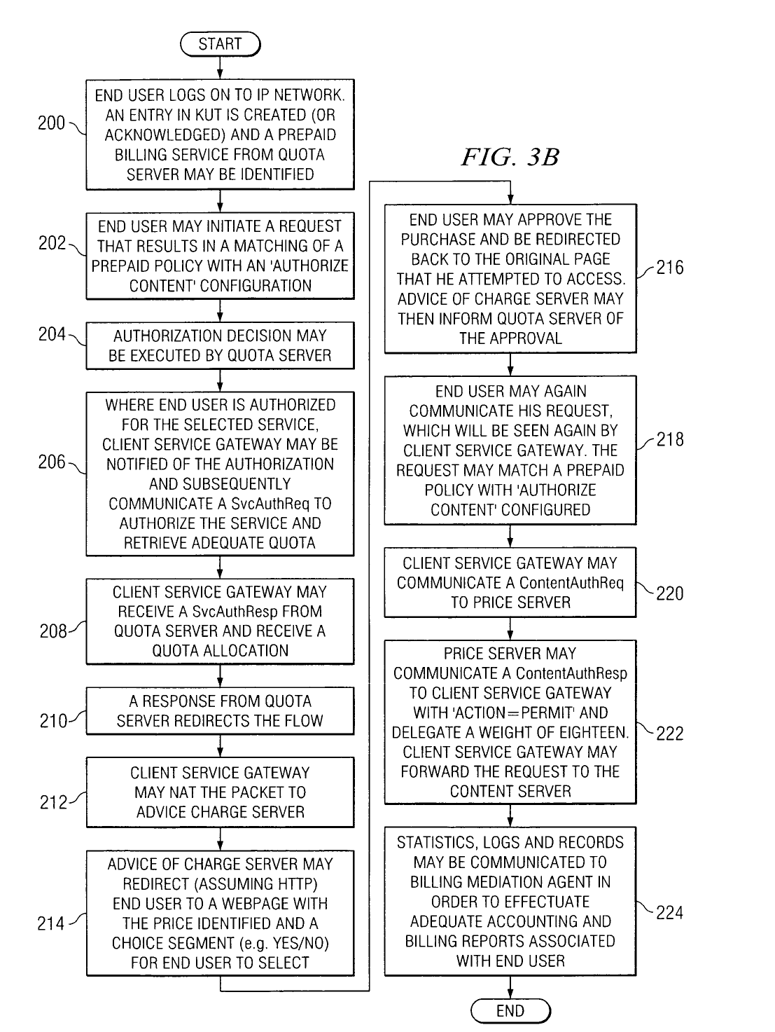

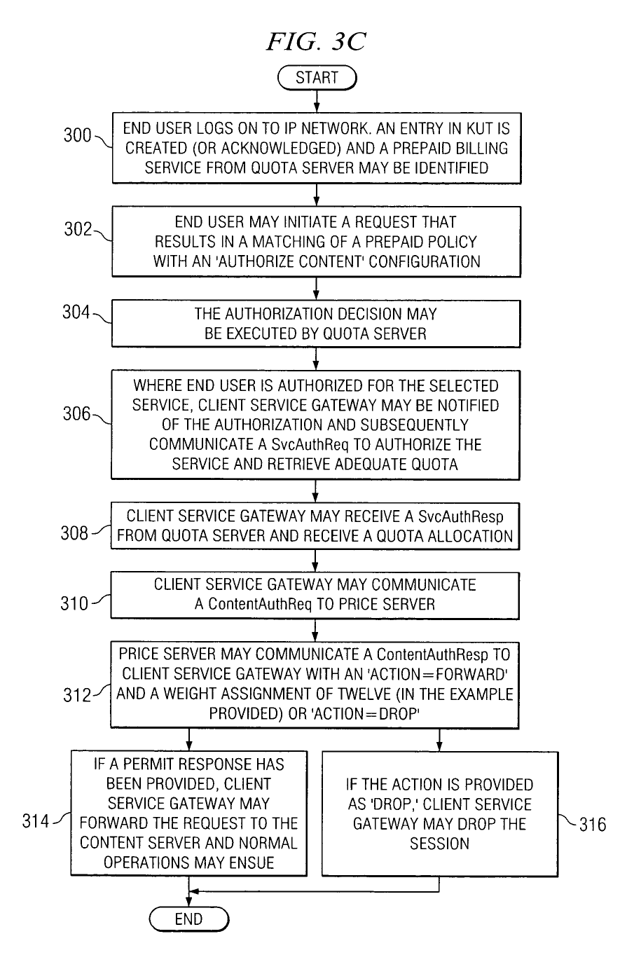

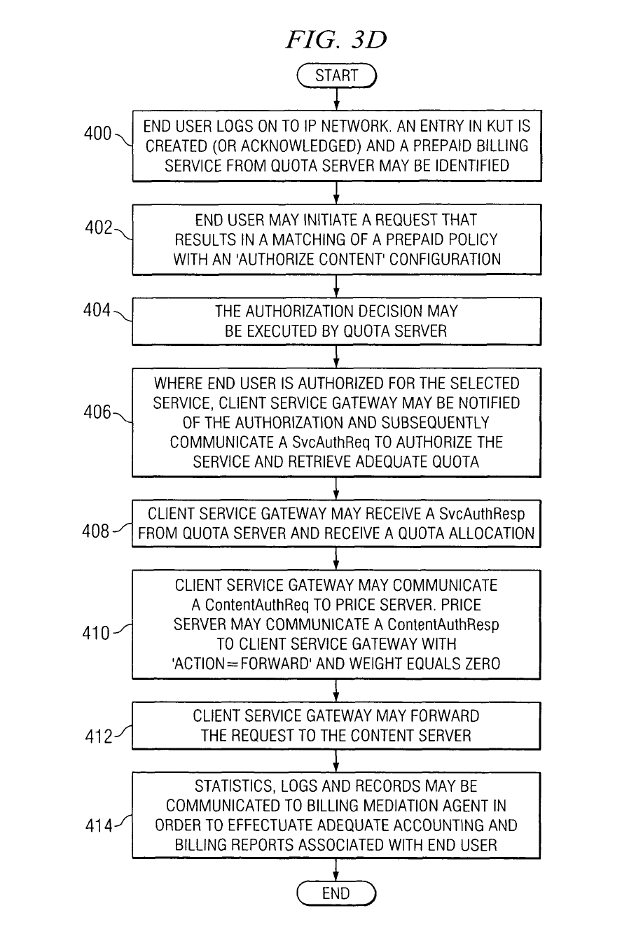

Note that the arrangement of the elements within CSG 14 and billing system element 40 is arbitrary and has been offered as just one (amongst many) potential configuration to be used to execute the operations of communication system 10 as described herein. Because these elements may be provided in software, hardware, or in any other module, component, device, or object, they may be combined (or provided externally) where appropriate and based on particular needs. Considerable flexibility is provided by these elements in that they may be arranged in any suitable manner and communicate with one another in various ways. The embodiment of FIG. 1 is only an example used for purposes of teaching and, accordingly, should be construed as such. Additional details relating to the functionality and operation of these elements are provided below with reference to FIGS. 3A-D.

End user 12 is a client, customer, entity, source, or object seeking to initiate network communication in communication system 10 via IP network 20. End user 12 may be inclusive of devices used to initiate a communication, such as a computer, a personal digital assistant (PDA), a laptop or an electronic notebook, a telephone, a mobile station, or any other device, component, element, or object capable of initiating voice or data exchanges within communication system 10. End user 12 may also be inclusive of a suitable interface to the human user, such as a microphone, a display, a keyboard, or other terminal equipment (such as for example an interface to a personal computer or to a facsimile machine in cases where end user 12 is used as a modem). End user 12 may also be any device that seeks to initiate a communication on behalf of another entity or element, such as a program, a database, or any other component, device, element, or object capable of initiating a voice or a data exchange within communication system 10. Data, as used herein in this document, refers to any type of packet, numeric, voice, video, graphic, or script data, or any type of source or object code, or any other suitable information in any appropriate format that may be communicated from one point to another.

RAN 16 is a communications interface between end user 12 and SGSNs 18a and 18b. RAN 16 may comprise a base transceiver station and a base station controller in one embodiment. The communications interface provided by RAN 16 may allow data to be exchanged between end user 12 and any number of selected elements within communication system 10. RAN 16 may facilitate the delivery of a request packet generated by end user 12 and the reception of information sought by end user 12. RAN 16 is only one example of a communications interface between end user 12 and SGSNs 18a and 18b. Other suitable types of communications interfaces may be used for any appropriate network design and be based on specific communications architectures in accordance with particular needs.

SGSNs 18a and 18b and GGSNs 32a and 32b are communication nodes or elements that cooperate in order to facilitate a communication session involving end user 12. GGSNs 32a-b are communications nodes operating in a GPRS environment that may be working in conjunction with multiple SGSNs 18a and 18b to provide a communications medium in a GPRS service network. GGSNs 32a and 32b may be inclusive of a walled garden (providing a security or an access functionality to communication system 10) or any other suitable mechanism that a network operator may choose to implement in providing some connectivity for a network. GPRS represents a packet-based data bearer service for communication services that may be delivered as a network overlay for any type of suitable network configuration or platform. GPRS may support multiple internet communication protocols and may enable existing IP, point to point protocol (PPP), or any other suitable applications or platforms to operate over a given network.

When end user 12 changes between SGSN 18a and 18b, the change may be communicated to CSG 14 by any appropriate node such as a selected GGSN 32a or 32b. This could be effectuated by a remote access dial-in user service (RADIUS) accounting message via a start signal or an interim update signal. This could also be reflected in a vendor-specific attribute that indicates the new SGSN being different from the current SGSN being used by end user 12. That message may also be communicated to billing system element 40 indicating the change in SGSN. The change in SGSN may result in quota data being returned to billing system element 40 for this particular data such as, for example, prepaid content. Pricing may vary for prepaid content depending on the geographic position of end user 12, roaming off network, or which SGSN is currently being implemented. Additionally, for example, pricing may also be different based on a given fee structure such as pricing per download, pricing per byte, or pricing for a selected time interval. Alternatively, any other parameter may be used in order to vary billing rates provided for a given end user 12. A selected GGSN 32a or 32b may report the change in SGSN by end user 12 via RADIUS messaging. Alternatively, this signaling may be provided by any data exchange or architected in any suitable communication standard or protocol in accordance with particular needs.

IP network 20 represents a series of points or nodes of interconnected communication paths for receiving and transmitting packets of information that propagate through communication system 10. IP network 20 offers a communicative interface between end user 12 and selected GGSNs 32a-b and may be any local area network (LAN), wireless local area network (WLAN), metropolitan area network (MAN), wide area network (WAN), virtual private network (VPN), or any other appropriate architecture or system that facilitates communications in a network environment. IP network 20 may implement a user datagram protocol (UDP)/internet protocol (UDP/IP) connection and use a transmission control protocol (TCP/IP) communication language protocol in particular embodiments of the present invention. However, IP network 20 may alternatively implement any other suitable communication protocol for transmitting and receiving data packets within communication system 10.

CSG 14 is a network element that may be inserted into a data flow that may view, extract, identify, access, or otherwise monitor information included within the data flow. CSG 14 may handle the enforcement of access, quota distribution, and accounting that is provided by the information retrieved from elements included within billing system element 40. CSG 14 may generally deduct quota after it has been properly allocated and, subsequently, retrieve additional quota when that quota allocation has been consumed. In a general sense, CSG 14 may be responsible for quota enforcement for end user 12. CSG 14 may include any suitable software, hardware, components, modules, devices, elements, or objects to facilitate the operations thereof.

In operation of an example embodiment, CSG 14 may extract IP source address information associated with end user 12. The IP source address may be used to determine an identity (or profile) of end user 12 that may be stored in KUT 26. Alternatively, CSG 14 may extract or identify any information within the data flow that provides a correlation between end user 12 and a given data flow. CSG 14 may also be a client-aware device that provides or offers some service or feature to end user 12. Such services may be based on an effective mapping between a source IP address of a given address packet and a user profile or information associated with end user 12. CSG 14 may utilize a source IP address in providing services or features to end user 12. CSG 14 may include a RADIUS component that may receive RADIUS updates and parse the updates. In addition, CSG 14 may execute some action based on the RADIUS updates it receives. CSG 14 may be provided with accounting, authorization and authentication (AAA) capabilities where appropriate. Alternatively, these capabilities may be provided external to CSG 14, for example, in a AAA server.

There are other reasons why a device or a component may seek to identify the source (end user 12) associated with a communication session or data flow. For example, some devices may wish to identify end user 12 for authorization purposes. In another example, a device may wish to maintain user profiles for billing or accounting records (for example, in conjunction with per-user accounting) or to provide for content billing information. Alternatively, a device or a component may use the identification of end user 12 to provide for any other type of suitable client-aware service, tool, or feature according to the particular needs of network operators. Additional services may be related to areas such as routing, permissions or access-granting mechanisms, priority, quality of service (QoS), firewalling, content filtering, or any other suitable parameters or policies where user-aware characteristics serve as a basis for a network service implementation.

In an example scenario, end user 12 may have a communication session established with SGSN 18a where a certain amount of money from an account of end user 12 is translated into a download of a given number of bytes. When end user 12 moves to SGSN 18b, end user 12 may be permitted to download a different number of designated bytes for the same amount of money or billing rate. The SGSN change may be detected by GGSN 32a or 32b whereby the selected GGSN communicates an accounting update to CSG 14. CSG 14 may then return all downloaded quota for end user 12 and notify billing system element 40 of the change in SGSN. CSG 14 may also communicate an acknowledgement to the selected GGSN for the message provided thereto. CSG 14 may then download the appropriate quota information for end user 12 again. This information may be retrieved from quota server 42 or alternatively from any other suitable database or storage element provided within billing system element 40 or provided external thereto. Billing system element 40 may be aware of the location change and send quota information to CSG 14 based on new financial parameters or new tariff characteristics that apply to the new location or the change in network parameters.

Loggen element 24 is a storage element operable to build billing records and communicate the billing records to BMA 44 based on information provided by KUT 26. Even in cases where the information returned by KUT 26 reflects a null (e.g., no active BMA), this may be communicated to GTP element 30a, which may use the value to determine the destination and queue(s) to use or to invoke for a corresponding billing record. Loggen element 24 may also operate to store data for later use and execute all formatting for billing records to be communicated to BMA 44. Loggen element 24 may be implemented using hardware, software, or any other suitable element or object operable to store information and to generate a billing record to be communicated to BMA 44. Loggen element 24 may communicate with BMA 44 in order to log quota usage data associated with end user 12. Loggen element 24 may generate logging records or billing records and additionally send messages to billing system element 40 associated with a change in SGSN.

KUT 26 is a data storage element that manages one or more correlations between the ID of end user 12 and a corresponding IP address. KUT 26 may also store information relating to BMA 44, previously designated to end user 12, and BMA 44 may be invoked when additional information associated with end user 12 is communicated to CSG 14. KUT 26 may be consulted as additional billing records are created in order to determine that BMA 44 should receive selected billing records. KUT 26 may also include an application program interface (API) that may be implemented in order to obtain user ID information for an IP address from a data flow.

CSG 14 and billing system element 40 may implement any suitable communications protocol in order to exchange information. In an example embodiment, GTP elements 30a-d may be used as a communications protocol or platform for such communications. Alternatively, CSG 14 and billing system element 40 (or BMA 44) may implement any communications protocol or tunneling communication link in order to provide for a suitable data exchange. GTP elements 30a-d may be included in CSG 14 or provided external thereto and be GTP or non-GTP based where appropriate. In one embodiment, GTP elements 30a-d are software communication protocols that describe the acknowledgement (or ACKing) and handshaking operations that may allow recognition of active, operational, and disabled states associated with BMA 44. In addition, GTP elements 30a-d may facilitate the formatting, header information, sequencing, and other communication parameters in order to effectively deliver data or information between CSG 14 and BMA 44.

In operation of an example embodiment, a packet may be delivered to CSG 14. The first packet in the data flow may be associated with end user 12 and analyzed by CSG 14. CSG 14 may operate to save selected data and (depending on whether it is a hypertext transfer protocol (HTTP) request or a non-HTTP request) suitably discard other information. In the case where the data flow does not include an HTTP request, CSG 14 may simply retain certain information about the data flow and potentially save that information until the flow ends. Where an HTTP request is made, information may exist that is provided by a browser and additional information may be offered about the uniform resource locator (URL), which may be used by CSG 14. In addition, information about which location in the network end user 12 is attempting to access may also be used by CSG 14. CSG 14 may perform a sniffing operation in this sense and glean information from packets included within a data flow. Other information to be extracted from HTTP requests or non-HTTP requests may include source and destination address information, how long the communication session lasted, how many bytes were sent or received by end user 12, or any other suitable parameters or properties associated with end user 12, the location to be accessed, or the data flow initiated by end user 12.

A billing record may then be created within CSG 14 and sent to BMA 44. A look-up operation may then be performed in order to correlate the IP address of end user 12 in KUT 26 to the user ID that may be included in that billing record. With this information provided, BMA 44 may now be assigned for this end user (if end user 12 is a new user). If this information or data flow is associated with an existing end user 12, it may be determined that BMA 44 was previously used by end user 12.

Quota manager element 36 is an element that manages quota information for services subscribed to by end user 12. Quota manager element 36 also provides an interface between GGSNs 32a and 32b and billing system element 40 and may receive a communication that indicates a change in SGSN. Quota manager element 36 may also identify new and old identifiers or pointers for selected SGSNs involved in the communication session and notify billing system element 40. Quota manager element 36 may also communicate with billing system element 40 in order to exchange information associated with funding for end user 12. Quota manager element 36 may also receive RADIUS updates from GGSN 32a or 32b that reflect the current status associated with end user 12.

Billing system element 40 is an object that manages the billing and access policies associated with a given end user 12. In one embodiment, billing system element 40 includes quota server 42, BMA 44, price server 50, and advice of charge server 60. CSG 14 may communicate with billing system element 40 in order to retrieve information or learn of billing policies for end user 12. The operations and processes associated with the elements included within billing system element 40 are described below with reference to FIGS. 3A-3D.

It is critical to note that CSG 14 and billing system element 40 may include any suitable elements, hardware, software, objects, or components capable of effectuating their operations or additional operations where appropriate. Additionally, any one or more of the elements included in CSG 14 and billing system element 40 may be provided in an external structure or combined into a single module or device where appropriate. Moreover, any of the functions provided by these two elements may be offered in a single unit or single functionalities may be arbitrarily swapped between CSG 14 and billing system element 40. The embodiment offered in FIG. 1 has been provided for purposes of example only. The arrangement of elements (and their associated operation(s)) may be reconfigured significantly in any other appropriate manner in accordance with the teachings of the present invention.

FIG. 2 is a simplified block diagram of KUT 26 included within communication system 10 in accordance with one embodiment of the present invention. KUT 26 may operate to manage or correlate user ID information with IP address data from a given communication or data flow. A number of entries may be included within KUT 26 that execute this correlation. For example, an entry may be provided as key address ‘1.1.1.1’ with a data field in a first segment that defines BMA 44 (data field #1) and a data field in a second segment that identifies a user ID for that IP address as some person or entity (data field #2). This is illustrated by the ‘John Smith’ entry in FIG. 2.

KUT 26 may also identify or store current SGSN information (data field #3) for end user 12 in a third segment. KUT 26 may receive RADIUS updates and maintain an end user's IP address and new SGSN that is being used. KUT 26 may be accessed in order to indicate that end user 12 has an IP address of 1.1.1.1. Such an address may correspond to ‘John Smith’ and an identifier of SGSN #1 (e.g. its IP address) or that ‘John Smith’ is now engaging SGSN #2 (reflected by its identifier, e.g. its IP address). KUT 26 has the capability of recognizing old and new SGSNs and may further add a capability to recognize changes therewith.

In operation, KUT 26 may return a given BMA 44 to use as the destination for all billing records for a particular session, data flow, or end user 12 in accordance with one or more of the following example guidelines. If an element with an already known user ID exists in KUT 26 and corresponds to any requested IP address, the identification (IP address) of the selected BMA 44 may be forwarded from KUT 26 to the caller entity. Where requested elements with user IDs exist, the selected BMA 44 for a first IP request may be returned.

If no IP address has a corresponding element in KUT 26, KUT 26 may notify loggen element 24 that no user ID is present in the table. When loggen element 24 determines that no user ID information will be obtained, it may communicate with KUT 26 and deliver source and destination IP addresses in order to assign BMA 44. KUT 26 may also operate to accurately recall the IP address associated with an identification correlating to end user 12. In an example scenario, CSG 14 may not know the identity of end user 12 and therefore an IP source address or some other user-identifying data is needed. The IP address may be dynamically assigned when an associated device is activated, e.g., a cellular telephone is turned on. The IP address may be assigned by any suitable element such as GGSN 32a or 32b, for example. Alternatively, an IP source address may be assigned or designated in any other suitable manner. KUT 26 may now be implemented to retrieve the user ID name associated with the IP address correlating to end user 12. This information may be positioned in a billing record that may be used to create a bill for a given end user 12. This may also be used (for example) to track information such as how many bytes were uploaded by end user 12 (byte counts) or how many URL addresses were accessed (or which URL addresses were accessed) by a given end user 12.

KUT 26 is thus provided with the capability of mapping the source IP address (or any other end user 12 parameter) to a user ID. The user ID may be obtained from an external database where appropriate or any other suitable location. Alternatively, the user ID may be extracted from a RADIUS flow, a terminal access controller access control system (TACACS) communications flow, a diameter communications flow, or any other suitable communications protocol flow, communication session, or data exchange. The database may be populated at any suitable time and updated using any suitable mechanism, such as via the sniffing of RADIUS or TACACS flows.

FIG. 3A is a simplified flowchart illustrating an example flow associated with price server 50. The flowchart may begin at step 100 where end user 12 logs on to IP network 20. An entry in KUT 26 is created (or acknowledged) and a prepaid billing service from quota server 42 may be identified. At step 102, end user 12 may initiate a request that results in a matching of a prepaid policy with an ‘authorize content’ configuration. In general, an inquiry is being made as to whether or not end user 12 is authorized for a selected service. The authorization decision is generally based on a financial account balance or service access policy and may be executed by quota server 42 at step 104. Where end user 12 is authorized for the selected service, CSG 14 may be notified of the authorization and subsequently communicate a Service Authorization Request (SvcAuthReq) to authorize the service and retrieve adequate quota at step 106. The service could be any suitable operation, feature, capability or process being provided to end user 12. For example, the service could relate to the ability to download a certain type of file (e.g. JPEG files).

At step 108, CSG 14 may receive a Service Authorization Response (SvcAuthResp) from quota server 42 and receive a quota allocation. CSG 14 may communicate a Content Authorization Request (ContentAuthReq) to price server 50 at step 110. In a general sense, this could equate to a “price check” operation being executed. For example, end user 12 may seek to purchase a given unit and, further, seek to confirm the price of the unit before proceeding. At step 112, price server 50 may communicate a Content Authorization Response (ContentAuthResp) to CSG 14 with an ‘Action=Forward’ and a weight assignment of twelve (in the example provided). Thus, step 112 reflects the response to the “price check” and offers information about how much a unit costs (e.g. a weight of twelve). End user 12 is being authorized for the specific type of service (e.g. the ability to download JPEGs) that was requested.

At this point, an amount of money has been secured (from step 102) for the selected service and the price of the selected service has been confirmed or verified. CSG 14 may now forward the request to a destination server (i.e. the ultimate destination, e.g. yahoo.com) at step 114. Subsequent to this operation, at step 116, statistics logs and records may be communicated to BMA 44 in order to effectuate adequate accounting and billing reports associated with end user 12.

FIG. 3B is a simplified flowchart illustrating an example flow associated with advice of charge server 60. Some of the initial steps of FIG. 3B are similar to those of FIG. 3A as end user 12 logs on to a given network and is allocated a certain amount of quota. Thus, the flowchart may begin at step 200 where end user 12 logs on to IP network 20. An entry in KUT 26 is created (or acknowledged) and a prepaid billing service from quota server 42 may be identified. At step 202, end user 12 may initiate a request that results in a matching of a prepaid policy with an ‘authorize content’ configuration. The authorization decision may be executed by quota server 42 at step 204. Where end user 12 is authorized for the selected service, CSG 14 may be notified of the authorization and subsequently communicate a SvcAuthReq to authorize the service and retrieve adequate quota at step 206.

At step 208, CSG 14 may receive a SvcAuthResp from quota server 42 and receive a quota allocation. At step 210, a response from quota server 42 redirects the flow. In the example provided, quota server 42 communicates a ContentAuthResp to CSG 14 with ‘Action=NAT-Redirect’ where the NAT information is given as 1.1.1.1/8080. Thus, rather than sending the user data packet to the destination server specified (e.g. yahoo.com), the packet is directed to another location (i.e. advice of charge server 60). End user 12 is now effectively communicating with advice of charge server 60. CSG 14 may NAT the packet to advice of charge server 60 at step 212. At step 214, advice of charge server 60 may redirect end user 12 to a webpage (assuming HTTP) with the price identified and a decision block (e.g. yes/no) for end user 12 to select. This may equate to the browser used by end user 12 being directed to a different webpage. In a general sense, end user 12 is shown a purchase price and is then queried as to whether this is acceptable to him. End user 12 may approve the purchase at step 216 and be redirected back to the original page that he attempted to access. Advice of charge server 60 may then inform quota server 42 of the approval.

At step 218, end user 12 may again communicate his request, which will be seen again by CSG 14. The request may match a prepaid policy with ‘authorize content’ configured. CSG 14 may communicate a ContentAuthReq to price server 50 at step 220. Price server 50 may communicate a ContentAuthResp to CSG 14 with ‘Action=Permit’ and delegate a weight of eighteen (in one example) at step 222. CSG 14 may forward the request to the content server (i.e. yahoo.com, in the example offered). Subsequent to this operation, at step 224, statistics logs and records may be communicated to BMA 44 in order to effectuate adequate accounting and billing reports associated with end user 12.

FIG. 3C is a simplified flowchart illustrating an example flow associated with L3/L4/L7 filtering. FIG. 3C further illustrates the ability of price server 50 and quota server 42 to deny access or permission to some item or location that is being sought by end user 12. For example, certain network participants may not wish to allow certain end users to provide network equipment (e.g. servers) in an effort to avoid the payment of fees. Such may be the case in a multi-media messaging service (MMS) context, whereby an operator would prefer charges to be incurred on their servers and not on servers not owned by the operator. (NOTE: MMS is a communications protocol that allows for the exchange of pictures via a telephone and has only been offered for purposes of example.) Other applications may include walled garden environments in which it would behoove a network operator to restrict access to certain locations. In other examples, such an operation may be appropriate to limit access to certain subject matter on the network (e.g. restricting certain family members access to designated sites).

Some of the initial steps of FIG. 3C are similar to those of FIGS. 3A-B as end user 12 logs on to a given network and is allocated a certain amount of quota. Accordingly, the flowchart may begin at step 300, where end user 12 logs on to IP network 20. An entry in KUT 26 is created (or acknowledged) and a prepaid billing service from quota server 42 may be identified. At step 302, end user 12 may initiate a request that results in a matching of a prepaid policy with an ‘authorize content’ configuration. The authorization decision may be executed by quota server 42 at step 304. Where end user 12 is authorized for the selected service, CSG 14 may be notified of the authorization and subsequently communicate a SvcAuthReq to authorize the service and retrieve adequate quota at step 306.

At step 308, CSG 14 may receive a SvcAuthResp from quota server 42 and receive a quota allocation. CSG 14 may communicate a ContentAuthReq to price server 50 at step 310. This is the “price check” operation, as described above. At step 312, price server 50 may communicate a ContentAuthResp to CSG 14 with an ‘Action=Forward’ and a weight assignment of twelve (in the example provided) or ‘Action=Drop.’ Note that if the action is provided as ‘Forward’ but quota server 42 does not prefer to offer the price, the weight TLV is not necessarily included. Thus, if a permit response has been provided, CSG 14 may forward the request to the content server and normal operations may ensue at step 314. In the alternative, if the action is provided as ‘Drop,’ CSG 14 may drop the session at step 316. In the drop scenario, note that a flag may be provided in the stats record to indicate the filtering operation.

FIG. 3D is a simplified flowchart illustrating an example flow associated with a quota management offload operation. In a general sense, FIG. 3D represents a scenario in which quota server 42 can release quota allotments on a per-flow basis. Thus, instead of being granted a huge chunk of (financial) buying power, the quota allocations are meted out for the exact amount requested. Price server 50 may be utilized by quota server 42 in order to ensure the proper amount is debited from an end user account.

Some of the initial steps of FIG. 3D are similar to those of FIGS. 3A-C as end user 12 logs on to a given network and is allocated a certain amount of quota. Thus, the flowchart may begin at step 400 where end user 12 logs on to IP network 20. An entry in KUT 26 is created (or acknowledged) and a prepaid billing service from quota server 42 may be identified. At step 402, end user 12 may initiate a request that results in a matching of a prepaid policy with an ‘authorize content’ configuration. The authorization decision may be executed by quota server 42 at step 404. Where end user 12 is authorized for the selected service, CSG 14 may be notified of the authorization and subsequently communicate a SvcAuthReq to authorize the service and retrieve adequate quota at step 406.

At step 408, CSG 14 may receive a SvcAuthResp from quota server 42 and receive a quota allocation. Note that appropriate codes may be provided in order to distinguish between end user 12 not being allowed to access the service and no quota being available. At step 410, CSG 14 may communicate a ContentAuthReq to price server 50. Price server 50 may communicate a ContentAuthResp to CSG 14 with ‘Action=Forward’ and a weight equal to zero. In a general sense, price server 50 and quota server 42 are being used to manage charging for every transaction. Thus, price may be set to zero and the packet forwarded. CSG 14 does not need quota to handle this operation. Note that in alternative embodiments, price server 50 could provide quota in the ContentAuthResp to use in the transaction. At step 412, CSG 14 may forward the request to the content server. Subsequent to this operation, at step 414, statistics logs and records may be communicated to BMA 44 in order to effectuate adequate accounting and billing reports associated with end user 12.

Some of the steps illustrated in FIGS. 3A-D may be changed or deleted where appropriate and additional steps may also be added to the flowcharts. These changes may be based on specific communication architectures or particular interfacing arrangements and configurations of associated elements and do not depart from the scope or the teachings of the present invention. The interactions and operations of the elements within billing system element 40 and CSG 14, as disclosed in FIGS. 3A-D, have provided merely one example for their potential applications. Numerous other applications may be equally beneficial and selected based on particular networking needs.

Although the present invention has been described in detail with reference to particular embodiments, communication system 10 may be extended to any scenario in which end user 12 is provided with pricing decisions in the context of a wired or a wireless connection or coupling. This may also be extended to any other network architectures and include communications with some type of access server (e.g. a network access server (NAS), foreign agents, etc.). End user 12 may use a dedicated connection of some form or use forms of multiple access protocols where appropriate. Access may be associated with a PPP architecture or alternatively with layer three protocols over a layer two in accordance with particular needs. Moreover, significant flexibility is provided by communication system 10 in that any suitable one or more components may be replaced with other components that facilitate their operations. For example, RAN 16 and SGSNs 18a and 18b may be replaced by an access network or by a packet data serving node (PDSN). Additionally, GGSNs 32a and 32b may be replaced by a home agent or a NAS where appropriate.

Additionally, although communication system 10 has been described with reference to a number of elements included within CSG 14 and billing system element 40, these elements may be rearranged or positioned anywhere within communication system 10. In addition, these elements may be provided as separate external components to communication system 10 where appropriate. The present invention contemplates great flexibility in the arrangement of these elements as well as their internal components. For example, in an alternative embodiment CSG 14 may include billing system element 40 or BMA 44 or these elements may be provided in a single module. Moreover, although FIGS. 1 and 2 illustrate an arrangement of selected elements, such as CSG 14 inclusive of quota manager element 36, loggen element 24, or GTP elements 30a-d, numerous other components may be used in combination with these elements or substituted for these elements without departing from the teachings of the present invention. Additionally, CSG 14 may be positioned in any suitable point of a data flow such that it may extract information used for generating a billing record.

Numerous other changes, substitutions, variations, alterations, and modifications may be ascertained to one skilled in the art and it is intended that the present invention encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

1. An apparatus for managing network access, comprising:
a billing system element operable to receive one or more packets of a communication flow and to communicate with a price server, wherein the price server is operable to receive a query from the billing system element associated with a pricing parameter relating to a data segment to be accessed by an end user associated with the communication flow, and wherein the price server is operable to return a response to the billing system element that includes the pricing parameter relating to the data segment such that the end user can verify the pricing parameter before accessing the data segment.

2. The apparatus of claim 1, wherein the price server is further operable to provide a selected one of a drop and a forward action, the forward action resulting in the end user being permitted access to the data segment, and wherein the drop action restricts the end user such that he cannot access the data segment.

3. The apparatus of claim 1, wherein the price server is further operable to provide a quota allocation to the end user on a per-flow basis such that the end user is given an amount of quota that may substantially satisfy a current access request being made by the end user.

4. The apparatus of claim 1, wherein the billing system element is further operable to communicate with an advice of charge server, the advice of charge server operable to receive a query from the billing system element and to redirect a communication flow associated with the end user to a webpage that is operable to display one or more financial parameters associated with the data segment to the end user.

5. The apparatus of claim 4, wherein the webpage includes a decision block that allows the end user to select whether he would like to proceed to access the data segment based on one or more of the financial parameters.

6. The apparatus of claim 1, further comprising:
a Content Services Gateway coupled to the billing system element and operable to communicate with the billing system element in order to manage distribution of quota provided to the end user.

7. The apparatus of claim 6, wherein the Content Services Gateway includes a known user table (KUT) operable to store an internet protocol (IP) address associated with the end user, the KUT being further operable to store information associated with first and second network nodes being used by the end user.

8. The apparatus of claim 6, wherein the billing system element further comprises a quota server operable to store quota data for the end user that reflects an allotment of information to be provided to the end user, the quota server being operable to be updated in accordance with direction provided by the Content Services Gateway.

9. The apparatus of claim 6, wherein the Content Services Gateway further comprises a quota manager element operable to receive identifiers associated with first and second network nodes and to notify the billing system element of a change from the first network node to the second network node.

10. A method for managing network access, comprising:
receiving a query associated with a pricing parameter relating to a data segment to be accessed by an end user associated with a communication flow; and
returning a response to the query that includes the pricing parameter relating to the data segment such that the end user can verify the pricing parameter before accessing the data segment.

11. The method of claim 10, further comprising:
providing a selected one of a drop and a forward action in response to receiving the communication flow, the forward action resulting in the end user being permitted access to the data segment, wherein the drop action restricts the end user such that he cannot access the data segment.

12. The method of claim 10, further comprising:
providing a quota allocation to the end user on a per-flow basis such that the end user is given an amount of quota that may substantially satisfy a current access request being made by the end user.

13. The method of claim 10, further comprising:
redirecting the communication flow associated with the end user to a webpage that is operable to display one or more financial parameters associated with the data segment to the end user.

14. The method of claim 13, further comprising:
managing distribution of quota provided to the end user based on information being provided and associated with the pricing parameter.

15. The method of claim 13, further comprising:
storing quota data for the end user that reflects an allotment of information to be provided to the end user.

16. A system for managing network access, comprising:
means for receiving a query associated with a pricing parameter relating to a data segment to be accessed by an end user associated with a communication flow; and
means for returning a response to the query that includes the pricing parameter relating to the data segment such that the end user can verify the pricing parameter before accessing the data segment.

17. The system of claim 16, further comprising:
means for providing a selected one of a drop and a forward action in response to receiving the communication flow, the forward action resulting in the end user being permitted access to the data segment, wherein the drop action restricts the end user such that he cannot access the data segment.

18. The system of claim 16, further comprising:
means for providing a quota allocation to the end user on a per-flow basis such that the end user is given an amount of quota that may substantially satisfy a current access request being made by the end user.

19. The system of claim 16, further comprising:
means for redirecting the communication flow associated with the end user to a webpage that is operable to display one or more financial parameters associated with the data segment to the end user.

20. The system of claim 19, further comprising:
means for managing distribution of quota provided to the end user based on information being provided and associated with the pricing parameter.

21. The system of claim 19, further comprising:
means for storing quota data for the end user that reflects an allotment of information to be provided to the end user.

22. Software for managing network access, the software being embodied in a computer readable medium and comprising computer code such that when executed is operable to:
receive a query associated with a pricing parameter relating to a data segment to be accessed by an end user associated with a communication flow; and
return a response to the query that includes the pricing parameter relating to the data segment such that the end user can verify the pricing parameter before accessing the data segment.

23. The medium of claim 22, wherein the code is further is operable to:
provide a selected one of a drop and a forward action in response to receiving the communication flow, the forward action resulting in the end user being permitted access to the data segment, wherein the drop action restricts the end user such that he cannot access the data segment.

24. The medium of claim 22, wherein the code is further operable to:
provide a quota allocation to the end user on a per-flow basis such that the end user is given an amount of quota that may substantially satisfy a current access request being made by the end user.

25. The medium of claim 22, wherein the code is further operable to:
redirect the communication flow associated with the end user to a webpage that is operable to display one or more financial parameters associated with the data segment to the end user.

26. The medium of claim 25, wherein the code is further operable to:
manage distribution of quota provided to the end user based on information being provided and associated with the pricing parameter.

27. The medium of claim 25, wherein the code is further operable to:
store quota data for the end user that reflects an allotment of information to be provided to the end user.
